(19) United States
(12) Patent Application Publication
(10) Pub. No.: US 2016/0236841 A1
(43) Pub. Date: Aug. 18, 2016

(54) RETENTION MEMBER AND KIT OF PRODUCTS PACKAGED THEREWITH

(71) Applicant: Honor Metro Limited, Tortola (VG)

(72) Inventor: Yung Pun Cheng, Kowloon (HK)

(21) Appl. No.: 15/043,807

(22) Filed: Feb. 15, 2016

Related U.S. Application Data
(60) Provisional application No. 62/115,929, filed on Feb. 13, 2015.

(51) Int. Cl. B65D 73/00; A63H 33/28; F16M 13/02; B65D 85/00

(52) U.S. Cl. CPC B65D 73/0014; B65D 85/70; A63H 33/28; F16M 13/02

(57) ABSTRACT

A packaged kit of products that includes a backer card and at least one retention member for retaining multiple products between the retention member and the backer card. The retention member may include a retaining component including a first retaining section comprising a first collar portion and a first coupling portion, the first collar portion defining a first slot for retaining a first product. The retaining component may also include a second retaining section comprising a second collar portion and a second coupling portion, the second collar portion defining a second slot for retaining a second product. The retaining component may include a third retaining section extending between the first and second retaining sections that includes notches for securing a third product. At least one locking member may be coupled to and decoupled from the first and second retaining sections to secure the retention member to the backer card.

### CROSS-REFERENCE TO RELATED APPLICATIONS

The present application claims priority to U.S. Provisional Patent Application Ser. No. 62/115,929, filed on Feb. 13, 2015, the entirety of which is incorporated herein by reference.

### FIELD OF THE INVENTION

The present invention relates generally to a retention member for securing multiple products to a backer card and to a packaged kit of products that includes a retention member.

### BACKGROUND OF THE INVENTION

In consumer products industries, the manner in which products are packaged is important to both sellers and consumers. Specifically, manufacturing costs, aesthetics, ease of access by the consumer, ability of the consumer to see and potentially test the product, and other factors are considered during the design of consumer product packaging. Oftentimes products are packaged by coupling the products to base packaging structures using zip ties, cable ties, or other plastic members that require the consumer to use scissors or other cutting devices to separate the product from the package. This can be inconvenient when a cutting device is not accessible to the consumer at the time that the consumer desires to open the package and remove/access the product. Thus, a need exists for a new and improved product retention member and a packaged kit utilizing the same that overcomes the deficiencies of conventional product packaging.

### SUMMARY OF THE INVENTION

The present invention may be directed, in one aspect, to a packaged kit of products that includes a backer card and at least one retention member for retaining multiple products between the retention member and the backer card. The retention member may include a retaining component including a first retaining section comprising a first collar portion and a first coupling portion, the first collar portion defining a first slot for retaining a first product. The retaining component may also include a second retaining section comprising a second collar portion and a second coupling portion, the second collar portion defining a second slot for retaining a second product. The retaining component may include a third retaining section extending between the first and second retaining sections. Such a third retaining section may include notches for retaining a third product. At least one locking member may be coupled to and decoupled from the first and second retaining sections to secure the retention member to the backer card.

In another aspect, the invention may be a packaged kit of products comprising: a backer card having a front surface, an opposite rear surface, and a plurality of through-holes formed through the backer card from the front surface to the rear surface; and a first retention member comprising: a retaining component positioned adjacent to the front surface of the backer card, the retaining component comprising a first retaining section for securing a first product between the retaining component of the first retention member and the backer card and a second retaining section for securing a second product between the retaining component of the first retention member and the backer card, each of the first and second retaining sections comprising at least one coupling portion extending through one of the plurality of through-holes in the backer card; and at least one first locking member positioned adjacent to the rear surface of the backer card, the first locking member comprising at least one connector that cooperatively mates with one of the coupling portions of the first and second retaining sections of the retaining component to couple the first locking member to the retaining component, secure the first retention member to the backer card, and retain the first and second products between the backer card and the retaining component of the first retention member.

In yet another aspect, the invention may be a retention member comprising: a retaining component comprising: a first retaining section comprising a first collar portion and a first coupling portion, the first collar portion defining a first slot comprising a first nesting region and a first access region that forms a passageway into the first nesting region at a front edge of the retaining component; and a second retaining section comprising a second collar portion and a second coupling portion, the second collar portion defining a second slot comprising a second nesting region and a second access region that forms a passageway into the second nesting region at the front edge of the retaining component; and at least one locking member configured to be transitioned between: (1) a locked state in which the at least one locking member is coupled to at least one of the first coupling portion of the first retaining section and the second coupling portion of the second retaining section; and (2) an unlocked state in which the at least one locking member is separated from each of the first and second retaining sections.

In still another aspect, the invention may be a packaged kit of products comprising: a backer card having a front surface, an opposite rear surface, and at least one through-hole formed through the backer card from the front surface to the rear surface; and a monolithic retaining component positioned adjacent to the front surface of the backer card, the retaining component comprising: a first retaining section securing a first product between the retaining component and the backer card; a second retaining section securing a second product between the retaining component and the backer card; and a third retaining section securing a third product between the retaining component and the backer card; and wherein the first product is a bubble solution container, the second product is a bubble generating device, and the third product is a dish.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a front perspective view of a packaged kit of products in accordance with an embodiment of the present invention;

FIG. 2 is a rear perspective view of the packaged kit of products of FIG. 1;

FIG. 3 is a right-side view of the packaged kit of products of FIG. 1;

FIG. 4 is a left-side view of the packaged kit of products of FIG. 1;

FIG. 5 is an exploded front perspective view of the packaged kit of products of FIG. 1;

FIG. 6 is a rear perspective view of a first retention member including a retaining component and a locking member in an unlocked state in accordance with an embodiment of the present invention;

FIG. 7 is a front perspective view of the first retention member of FIG. 6;

FIG. 8 is a rear perspective view of the first retention member of FIG. 6 with the locking member and the retaining component in a locked state;

FIG. 9 is a front perspective view of the first retention member of FIG. 8;

FIG. 10 is a top view of the retaining component of the first retention member of FIG. 6;

FIG. 11 is a rear perspective view of a second retention member including a retaining component and a locking member in an unlocked state in accordance with an embodiment of the present invention;

FIG. 12 is a front perspective view of the second retention member of FIG. 11.

FIG. 13 is a rear perspective view of the second retention member of FIG. 11 with the locking member and the retaining component in a locked state; and

FIG. 14 is a front perspective view of the second retention member of FIG. 13.

### DETAILED DESCRIPTION OF THE INVENTION

The following description of the preferred embodiment(s) is merely exemplary in nature and is in no way intended to limit the invention, its application, or uses.

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

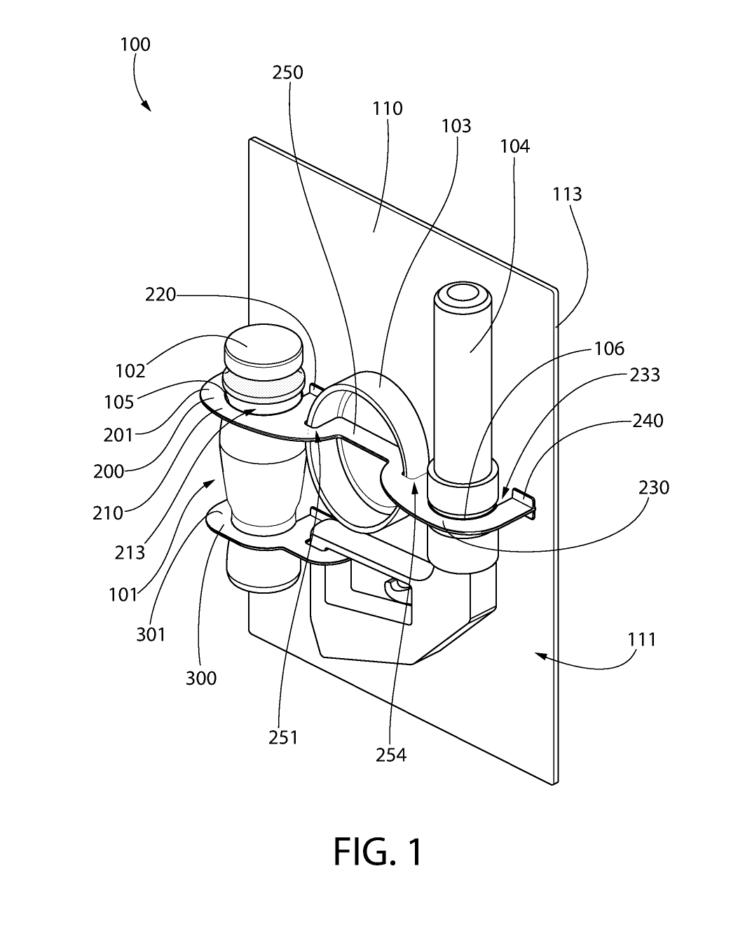

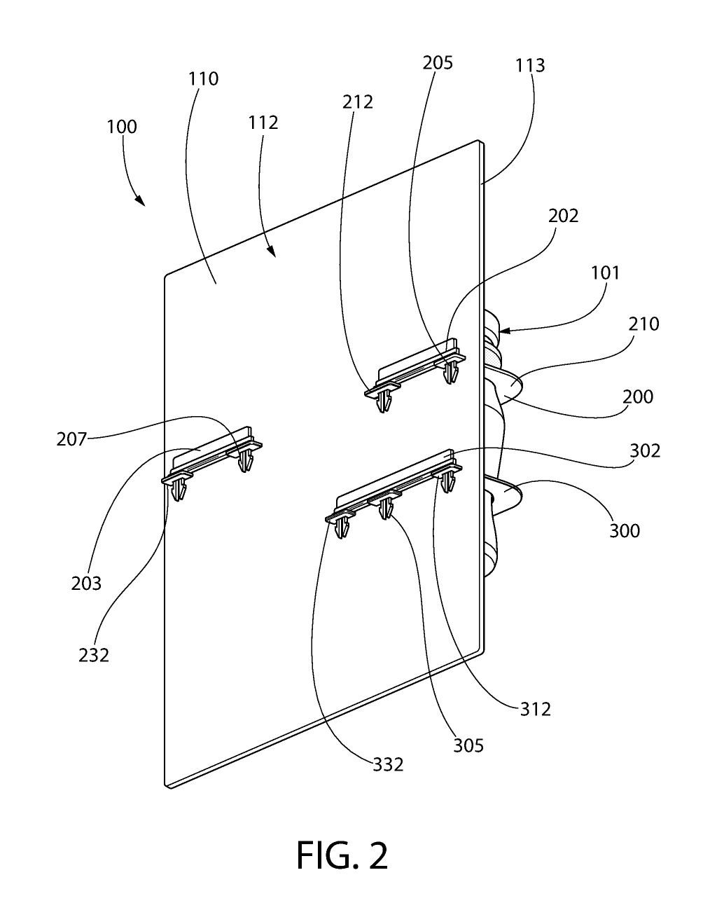

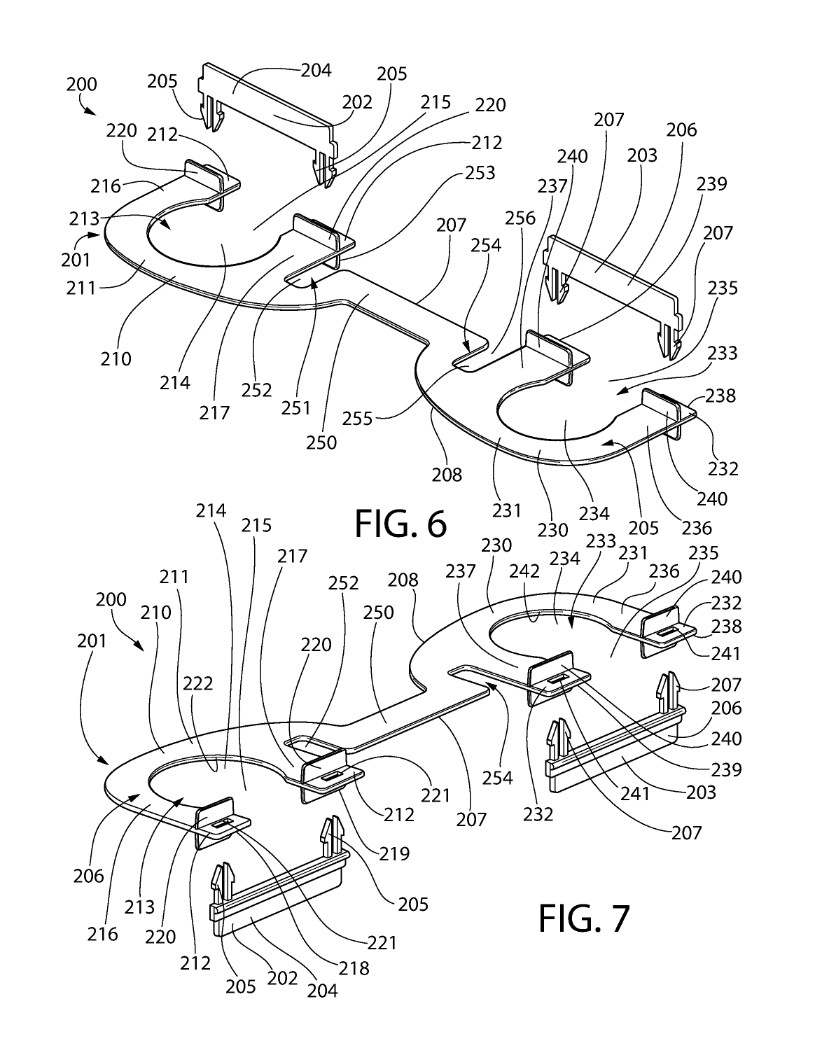

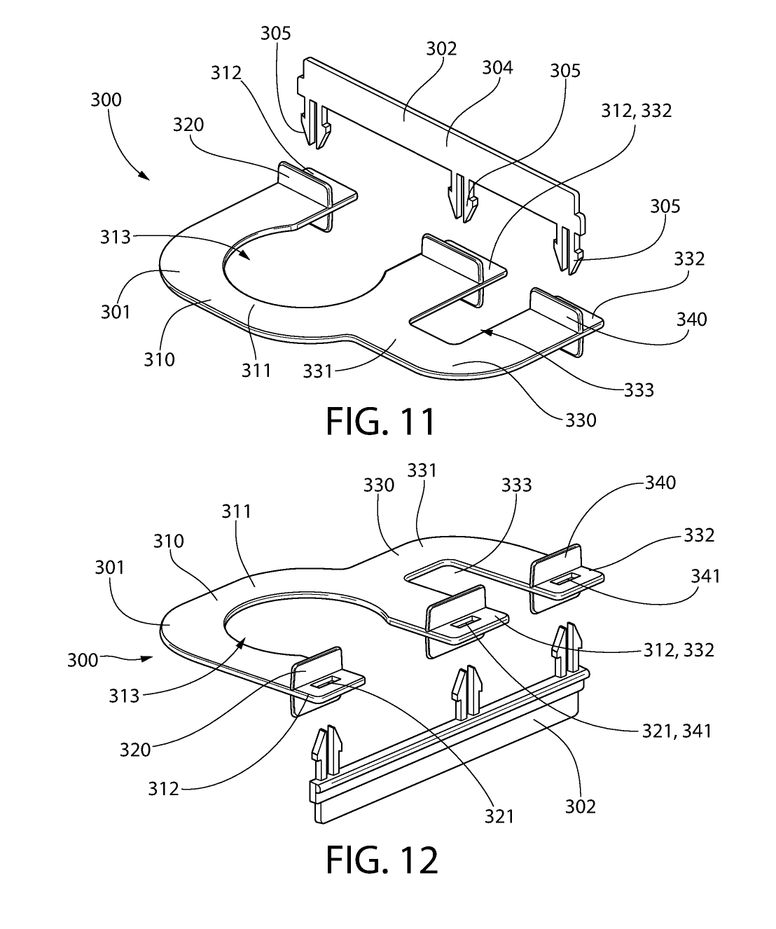

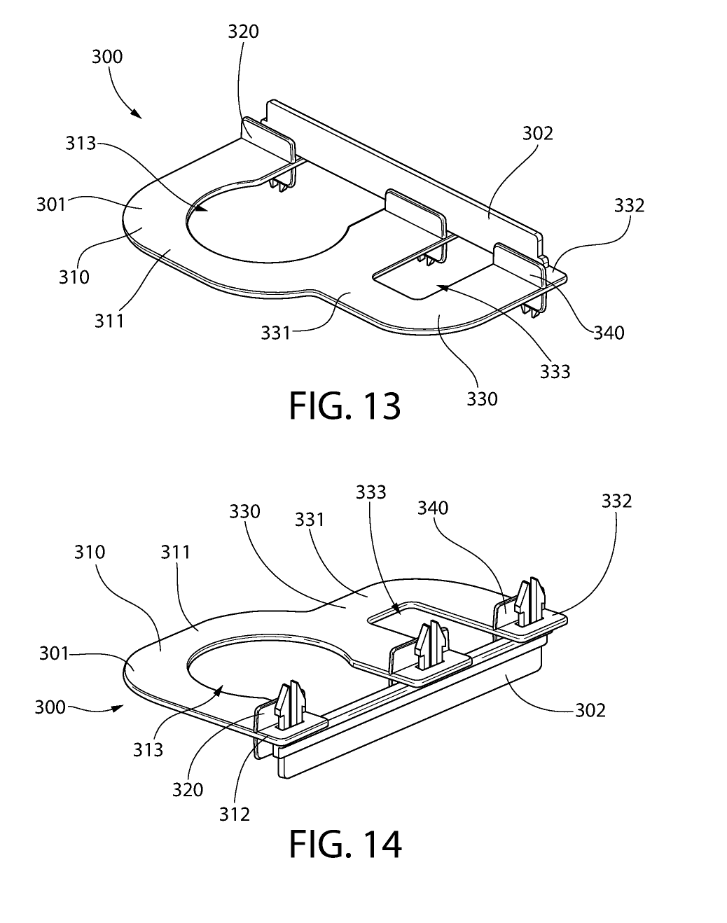

Referring first to FIGS. 1-5 concurrently, a packaged kit of products 100 is illustrated. The packaged kit of products 100 generally comprises a plurality of products 101, a backer card 110, a first retention member 200, and a second retention member 300. The first and/or second retention members 200, 300 are coupled to the backer card 110 and the plurality of products 101 are sandwiched between the first and/or second retention members 200, 300 and the backer card 110 to form the packaged kit of products 100. Although the first and second retention members 200, 300 are both illustrated in the drawings to secure the products to the backer card 110, the invention is not to be so limited in all embodiments and in certain other embodiments one of the first and second retention members 200, 300 may be used without the other. Thus, the first retention member 200 may be used and the second retention member 300 may be omitted and replaced with zip ties (i.e., cable ties) or the like, or with nothing at all. The structural details of the first retention member 200 will be provided below with reference to FIGS. 6-10. The structural details of the second retention member 300 will be provided below with reference to FIGS. 11-14.

In the exemplified embodiment, the plurality of products 101 comprises a first product 102, a second product 104, and a third product 103. In the exemplified embodiment, the first product 102 is a bubble solution container, the second product 104 is a bubble generating device, and the third product 103 is a dish. Thus, the products 101 may be ones that are intended to be used together. Specifically, in the exemplified embodiment the products may be used together as follows. The bubble solution may be poured out of the bubble solution container and into the dish. The bubble generating device (which may be a bubble gun as exemplified but is not limited to this manifestation in all embodiments) may then be dipped into the dish to adhere the bubble solution onto the bubble generating device. The bubble generating device may then be powered on to generate bubbles. However, the invention is not to be limited to the particular products used in the packaged kit of products 100 unless specifically claimed. Furthermore, the products 101 are not limited to being ones that can be utilized together. Thus, it is possible that in other embodiments other consumer products or the like may be packaged in the manner described herein.

The backer card 110 may in certain embodiments be a cardboard panel or board to which the products 101 are coupled via the first and/or second retention members 200, 300. Of course, the invention is not to be so limited in all embodiments and the backer card 110 may be formed of materials other than cardboard, such as plastic, wood, metal, or the like as desired. In certain embodiments the backer card 110 is substantially rigid to facilitate retaining the products 101 thereon using the first and/or second retention members 200, 300. The backer card 110 comprises a front surface 111 and an opposing rear surface 112. Furthermore, the backer card 110 comprises a peripheral edge 113 that extends between the front and rear surfaces 111, 112. In the exemplified embodiment, each of the front and rear surfaces 111, 112 is a flat, planar surface. However, the invention is not to be so limited and the front and/or rear surfaces 111, 112 may be contoured to achieve a desired aesthetic or to assist in securing the products 101 thereon. Furthermore, one or both of the front and/or rear surfaces 111, 112 of the backer card 110 may include indicia thereon, such as product instructions, general product information, manufacturer information, or the like. Finally, although the backer card 110 is illustrated as having a rectangular shape in the exemplified embodiment, the invention is not to be so limited and the backer card 100 may take on any other desired shape.

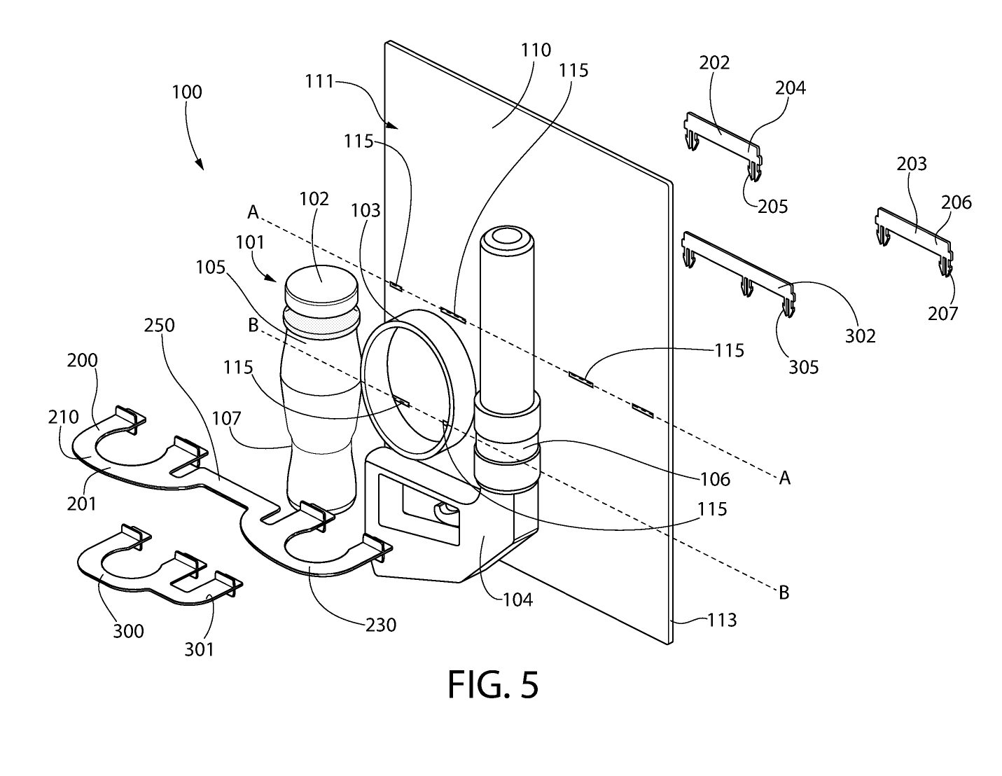

Referring briefly to FIG. 5, in the exemplified embodiment a plurality of through-holes 115 are formed through the backer card 110 and extend along a first axis from the front surface 111 of the backer card 110 to the rear surface 112 of the backer card 110. In the exemplified embodiment, there are four through-holes 115 aligned along a first transverse axis A-A and there are three through-holes 115 aligned along a second transverse axis B-B (only two of which are visible in FIG. 5). However, the exact number and in some instances the positioning of the various through-holes is not to be limiting of the present invention. Each of the through-holes 115 forms a passageway through the thickness of the backer card 110 to permit coupling of the first and second retention members 200, 300 to the backer card 110 as described herein below. Specifically, as discussed in more detail below, portions of the first and/or second retention members 200, 300 will extend through the through-holes 115 and be secured to the backer card 110 with a locking member 202, 203, 302. A discussion of FIGS. 1-5 will resume to describe the manner in which the first and second retention members 200, 300 are used to secure products to the backer card 110 after the first and second retention members 200, 300 are described in detail directly below.

Referring to FIGS. 6-10 concurrently, the details of the first retention member 200 will be described. In certain embodiments, the first retention member 200 is formed of a rigid plastic material. However, the invention is not to be so limited and other materials may be used as would be appreciated by those skilled in the art, including a lightweight metal or the like. The first retention member 200 generally comprises a retaining component 201 and a locking member 202. The retaining component 201 of the first retention member 200 comprises a first retaining section 210, a second retaining section 230, and a third retaining section 250. The first and second retaining sections 210, 230 are spaced apart by the third retaining section 250 which extends between the first and second retaining sections 210, 230.

The first retaining section 210 is configured to retain the first product 102 between the retaining component 201 and the backer card 110, the second retaining section 230 is configured to retain the second product 104 between the retaining component 201 and the backer card 110, and the third retaining section 250 is configured to retain the third product 103 between the retaining component 201 and the backer card 110. The structure of the first, second, and third retaining sections 210, 230, 250 and the manner in which they secure the first, second, and third products 102, 103, 104 to the backer card 110 will be described in more detail below.

In the exemplified embodiment, the retaining component 201 of the first retention member 200 is a unitary monolithic structure and the locking member 202 is a separate component from the retaining component 201 of the first retention member 200 that can be coupled to and decoupled/separated from the retaining component 201. Thus, the first, second, and third retaining sections 210, 230, 250 are all formed as a part of a unitary structure. This makes it much easier to secure multiple products to the backer card 110 simultaneously using the retaining component 201 because there is only one component to couple to the backer card 110 rather than multiple components or multiple zip ties. This also makes it easier for a consumer to separate the products from the packaging after purchase because the consumer only needs to decouple the one retention member 200 from the backer card 110 to achieve full access to all of the products packaged thereby (or two retention members when both the first and second retention members 200, 300 are used).

The retaining component 201 of the first retention member 200 comprises an upper surface 205, a lower surface 206, and a peripheral edge extending between the upper and lower surfaces 205, 206. The peripheral edge includes a front edge 207, a rear edge 208, and lateral edges 209 extending between the front and rear edges 207, 208. The rear edge 208 has convex portions in the first and second retaining sections 210, 250 and a straight portion in the third retaining section 230. The front edge 207 has concave portions in the first and second retaining sections 210, 250 and a straight portion in the third retaining section 230. The retaining component 201 may have a maximum length L measured between the lateral sides 209 of between 185 mm and 200 mm, a maximum width W measured between the front and rear edges 207, 208 of between 45 mm and 55 mm, and a thickness measured between the upper and lower surfaces 205, 206 of between 1 mm and 5 mm. Of course, dimensions outside of the above-noted ranges are possible in alternative embodiments and may depend on the dimensions of the backer card 110 to which the retaining component 201 is to be coupled and/or the dimensions of the products 101 to be retained by the retaining component 201. When the first retention member 200 is coupled to the backer card 110 to retain the products 101 between the retaining component 201 and the backer card 110, the front edge 207 of the retaining component 201 is adjacent to or faces the front surface 111 of the backer card 110. The products 101 are then retained and held within pockets that are formed between the retaining component 201 and the front surface 111 of the backer card 110 as described in more detail herein below.

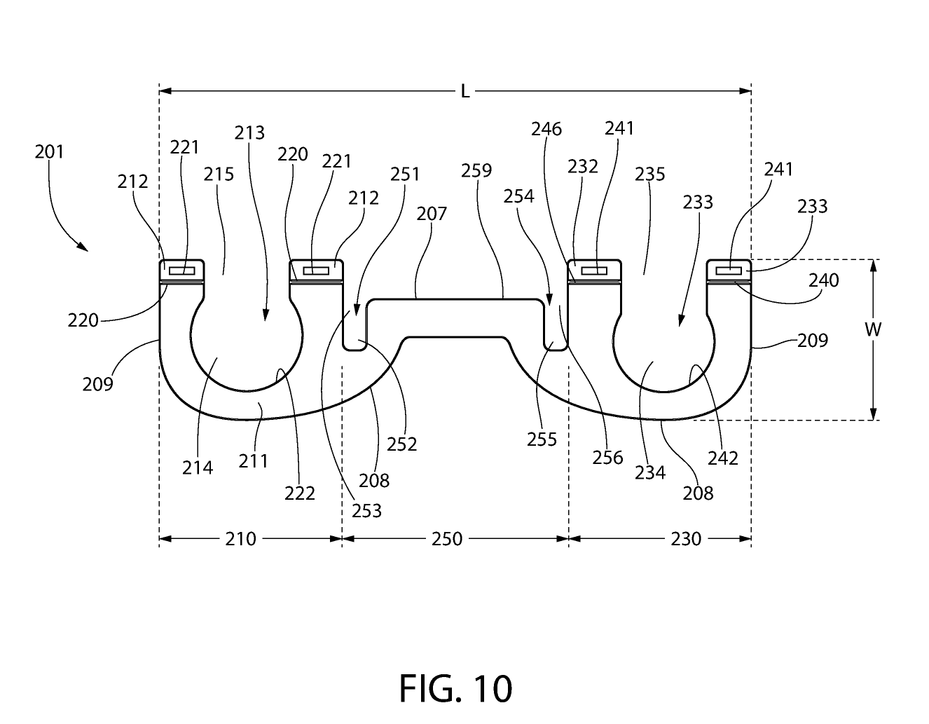

In the exemplified embodiment, the first and second retaining sections 210, 230 of the retaining component 201 have a very similar structure, and each will be described separately herein. Differences in the structure of the first and second retaining sections 210, 230 may include dimensions of the different portions thereof. Specifically, the slots described below may have different widths, lengths, and diameters depending on whether it is the slot of the first retaining section 210 or the slot of the second retaining section 230, as best illustrated in FIG. 10. However, these specific dimensional details are not to be limiting of the present invention in all embodiments and may be modified depending on the specific shape and dimensions of the product(s) being retained by the first retention member 200.

The first retaining section 210 comprises a first collar portion 211 and a first coupling portion 212. As discussed in more detail below, the first coupling portion 212 is the portion of the retaining component 201 that is coupled to the locking member 202 when the locking member 202 is coupled to the retaining component 201. The first collar portion 211 defines a first slot 213 configured to hold or retain the first product 102. The first slot 213 comprises a first nesting region 214 and a first access region 215. The first access region 215 is an opening at the front edge 207 of the retaining component 201 that forms a passageway into the first nesting region 214. Thus, the first slot 213 is open in that it is not fully enclosed by the first collar portion 211 of the first retaining section 210. This permits the first product 102 to be inserted into the first slot 213 through the first access region 215 and into the first nesting region 214 where it is retained by the first retaining section 210 of the retaining component 201. The first slot 213 is closed by the front surface 111 of the backer panel 110 when the retaining component 201 is coupled to the backer panel 110 or by the locking member 202 when the locking member 202 is coupled to the retaining component 201.

The first retaining section 210 comprises an inner edge 222 that defines the first slot 213. The inner edge 222 comprises a straight portion that defines the first access region 215 of the first slot 213 and a curved portion that defines the first nesting region 214 of the first slot 213. The curved portion of the inner edge 222 of the first retaining section 210 is concave and comprises a radius of curvature sufficient to enable the first product 102 (or other product) to be retained therein. Of course, the shape of the inner edge 222 may be different than that which is depicted in the drawings (square-shaped, V-shaped, or the like) depending on the shape of the product being nested within the first nesting region 214 of the first slot 213 of the first retaining section 210.

In the exemplified embodiment, the first retaining section 210 is a U-shaped portion of the retaining component 201. Thus, the first retaining section 210 comprises a first leg 216 and a second leg 217 that are connected by a bight of the U-shape. The first leg 216 terminates at a distal end 218 and the second leg 217 terminates at a distal end 219. The first slot 213 is defined in the region between the first and second legs 216, 217 of the first retaining section 210.

A stopper wall 220 is located on each of the first and second legs 216, 217 and prevents over-insertion of the first and second legs 216, 217 into the through-holes 215 of the backer card 210 as described in more detail below. The stopper walls 220 extend upwardly and downwardly from the legs 216, 217 at a location that is adjacent to but spaced from the distal ends 217, 218 of the first and second legs 216, 217. More specifically, each of the stopper walls 220 comprises a first portion extending from the upper surface 205 of the retaining component 201 and a second portion extending from the lower surface 206 of the retaining component 201. In alternative embodiments the stopper walls 220 may only extend from the upper surface 205 or the lower surface 206 of the retaining component 201, but not both. Each of the first and second portions of each of the stopper walls 220 extends from the retaining component 201 in a perpendicular manner.

The stopper wall 220 on each of the first and second legs 216, 217 divides the first retaining section 210 into the first collar portion 211 and the first coupling portion 212. Specifically, the portion of the retaining section 210 between the stopper wall 220 and the distal ends 218, 219 of the first and second legs 216, 217 is the first coupling portion 212 of the first retaining section 210. The remainder of the first retaining section 210 between the stopper wall 220 on the first leg 216 and the stopper wall 220 on the second leg 217 forms the first collar portion 211 of the first retaining section 210. When the first retention member 200 is coupled to the backer card 110, the first collar portion 211 of the first retaining section 210 is positioned on one side (i.e., adjacent to the front surface 111) of the backer card 110 and the first coupling portion(s) 212 are positioned on the other side (i.e., adjacent to the rear surface 112) of the backer card 110. The stopper walls 220 will be located on the same side as the first collar portion 211 (i.e., adjacent to the front surface 111 of the backer card 110, and possibly in direct surface contact with the front surface 111 of the backer card 110).

Each of the first coupling portions 212 comprises an aperture 221 formed through the retaining component 201 from the upper surface 205 to the lower surface 206. Specifically, the first coupling portion 212 of the first leg 216 comprises one of the apertures 221 in the region between the stopper wall 220 on the first leg 216 and the distal end 218 of the first leg 216. The first coupling portion 212 of the second leg 217 comprises one of the apertures 221 in the region between the stopper wall 220 on the second leg 217 and the distal end 219 of the second leg 217. Although described herein as apertures 221, the invention is not to be so limited and the apertures 221 may be replaced by protuberances or the like. Specifically, the apertures 221 or other feature that is used in place of the aperture should be configured to correspondingly mate with a feature on the locking member 202 to permit the locking member 202 to be coupled to and decoupled from the retaining component 201.

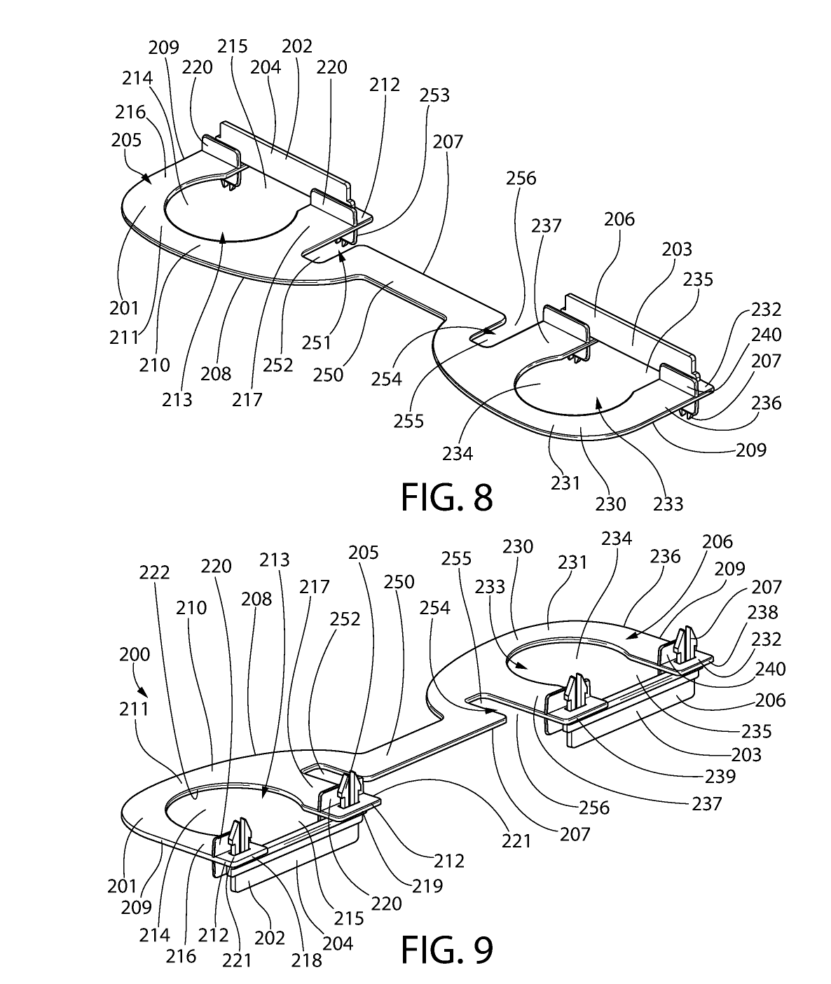

The locking member 202 is a flat plate-like structure having a body portion 204 and one or more locking protrusions 205 extending from the body portion 204. FIGS. 6 and 7 illustrate the locking member 202 in an unlocked state in which the locking member 202 is separated from the retaining component 201. FIGS. 8 and 9 illustrate the locking member 202 in a locked state in which the locking member 202 is coupled to the retaining component 201, and more specifically to the first retaining section 210 of the retaining component 201. In the exemplified embodiment, coupling the locking member 202 to the retaining component 201 comprises inserting the locking protrusions 205 into the apertures 221. The locking protrusions 205 comprise two prongs that are spaced by a gap so that the two prongs will flex inwardly towards one another and into the gap as the locking protrusions 205 are inserted into the apertures 221 until flange portions of the locking protrusions 205 extend through the apertures 221. The locking protrusions 205 will then flex back out to their biased position and the flange portions will retain the locking protrusions 205 within the apertures 221 by contact between the flange portions of the locking protrusions 205 and the rear surface 206 of the retaining component 201. When it is desired to separate the locking member 202 from the retaining component 201, the flange portions of the locking protrusions 205 are squeezed together so that they will fit through the apertures 221 and then the locking member 202 is moved in a direction away from the retaining component 201. The locking member 202 may be repetitively coupled to and decoupled from the retaining component 201 as desired. Thus, the retention member 200 is reusable if so desired.

Of course, as discussed above, in some embodiments the first coupling portions 212 may have protrusions and in such embodiments the locking member 202 may include apertures instead of the locking protrusions. In such embodiment, the protrusions of the first coupling portions 212 will mate with the apertures in the locking member 202 to couple the locking member 202 to the retaining component 201. Furthermore, other structural features and components may be used to permit repetitive coupling and decoupling of the locking member 202 to the retaining component 201, including hook-and-loop fasteners, threaded fasteners such as screws, or the like. The concept merely requires that there is some mating features on each of the locking member 202 and the first coupling portions 212 to permit repetitive coupling of the locking member 202 to and decoupling of the locking member 202 from the retaining component 201, and more specifically the first retaining section 210 thereof.

In still other embodiments, the locking member 202 may be omitted and the first coupling portions 212 may include features, such as flanges or the like, that permit the first coupling portions 212 to couple to the backer card 110 directly without the locking member 202 being required. For example, the coupling portions 212 may comprise locking protrusions similar to those that are associated with the locking member 202 in the exemplified embodiment. These locking protrusions may flex inwardly as the first coupling portions 212 are inserted into the through-holes in the backer card 110, and flange portions thereof may interact with the rear surface 112 of the backer card 110 to couple the retaining component 201 to the backer card 110. These same alternatives may also be used with the second retaining section 230 and the locking member 203.

The second retaining section 230 comprises a second collar portion 231 and a second coupling portion 232. As discussed in more detail below, the second coupling portion 232 facilitates coupling of the retaining component 201 to the locking member 203. The second collar portion 231 defines a second slot 233 configured to hold or retain the second product 104. The second slot 233 comprises a second nesting region 234 and a second access region 235. The second access region 235 is an opening at the front edge 207 of the retaining component 201 that forms a passageway into the second nesting region 234. Thus, the second slot 233 is open in that it is not fully enclosed by the second collar portion 231 of the second retaining section 230. This permits the second product 104 to be inserted into the second slot 233 through the second access region 235 and into the second nesting region 234 where it is retained by the second retaining section 230 of the retaining component 201. The second slot 233 is closed by the front surface 111 of the backer panel 110 when the retaining component 201 is coupled to the backer panel 110 or by the locking member 203 when the locking member 203 is coupled to the retaining component 201.

The second retaining section 230 comprises an inner edge 242 that defines the second slot 233. The inner edge 242 comprises a straight portion that defines the second access region 235 of the second slot 233 and a curved portion that defines the second nesting region 234 of the second slot 233. The curved portion of the inner edge 242 of the second retaining section 230 is concave and comprises a radius of curvature sufficient to enable the second product 104 to be retained therein. Of course, the shape of the inner edge 242 may be different than that which is depicted in the drawings (square-shaped, V-shaped, or the like) depending on the shape of the product being nested within the second nesting region 234 of the second slot 233 of the second retaining section 230.

The second retaining section 230 is a U-shaped portion of the retaining component 201. Thus, the second retaining section 230 comprises a first leg 236 and a second leg 237 that are connected by a bight of the U-shape. The first leg 236 terminates at a distal end 238 and the second leg 237 terminates at a distal end 239. The second slot 233 is defined in the region between the first and second legs 236, 237 of the second retaining section 230.

A stopper wall 240 is located on each of the legs 236, 237 and prevents over-insertion of the first and second legs 236, 237 into the through-holes 215 of the backer card 210 as described in more detail below. The stopper walls 240 extend upwardly and downwardly from the first and second legs 236, 237 at a location that is adjacent to but spaced from the distal ends 237, 238 of the first and second legs 236, 237. More specifically, each of the stopper walls 240 comprises a first portion extending from the upper surface 205 of the retaining component 201 and a second portion extending from the lower surface 206 of the retaining component 201. More specifically, each of the first and second portions of each of the stopper walls 240 extends from the retaining component 201 in a perpendicular manner.

The stopper wall 240 on each of the first and second legs 236, 237 divides the second retaining section 230 into the second collar portion 231 and the second coupling portion 232. Specifically, the portion of the second retaining section 230 between the stopper wall 240 and the distal end 238, 239 of the first and second legs 236, 237 is the second coupling portion 232 of the second retaining section 230. The remainder of the second retaining section 230 between the stopper wall 240 on the first leg 236 and the stopper wall 240 on the second leg 237 forms the second collar portion 231 of the second retaining section 230. When the first retention member 200 is coupled to the backer card 110, the second collar portion 231 of the second retaining section 230 is positioned on one side (i.e., adjacent to the front surface 111) of the backer card 110 and the second coupling portion(s) 232 are positioned on the other side (i.e., adjacent to the rear surface 112) of the backer card 110. The stopper walls 240 will be located on the same side as the second collar portion 231 (i.e., adjacent to the front surface 111 of the backer card 110, and possibly in direct surface contact with the front surface 111 of the backer card 110).

Each of the second coupling portions 232 comprises an aperture 241 formed through the retaining component 201 from the upper surface 205 to the lower surface 206. Specifically, the second coupling portion 232 of the first leg 236 comprises one of the apertures 241 in the region between the stopper wall 240 on the first leg 236 and the distal end 238 of the first leg 236. The second coupling portion 232 of the second leg 237 comprises one of the apertures 241 in the region between the stopper wall 240 on the second leg 237 and the distal end 239 of the second leg 237. Although described herein as apertures 241, the invention is not to be so limited and the apertures 241 may be replaced by protuberances or the like. Specifically, it is merely preferable that the apertures 241 or other feature that is used in place of the aperture be configured to correspondingly mate with a feature on the locking member 203 to permit the locking member 203 to be coupled to and decoupled from the retaining component 201.

The locking member 203 is a flat plate-like structure having a body portion 206 and one or more locking protrusions 207 extending from the body portion 206. FIGS. 8 and 9 illustrate the locking member 203 in a locked state in which the locking member 203 is coupled to the retaining component 201, and more specifically to the second retaining section 230 of the retaining component 201. FIGS. 6 and 7 illustrate the locking member 203 in an unlocked state in which the locking member 203 is separated from the retaining component 201. In the exemplified embodiment, coupling the locking member 203 to the retaining component 201 comprises inserting the locking protrusions 207 into the apertures 241. The locking protrusions 207 comprise two prongs that are spaced by a gap so that the two prongs will flex inwardly towards one another and into the gap as the locking protrusions 207 are inserted into the apertures 241 until flange portions of the locking protrusions 207 extend through the apertures 241. The locking protrusions 207 will then flex back out to their biased position and the flange portions will retain the locking protrusions 207 within the apertures 241. When it is desired to separate the locking member 203 from the retaining component 201, the flange portions of the locking protrusions 207 are squeezed together so that they will fit through the apertures 241 and then the locking member 203 is moved in a direction away from the retaining component 201. The locking member 203 may be repetitively coupled to and decoupled from the retaining component 201 as desired and as discussed in more detail below.

Of course, as discussed above, in some embodiments the second coupling portions 232 may have protrusions and in such embodiments the locking member 203 may include apertures instead of the locking protrusions. In such embodiment, the protrusions of the second coupling portions 232 will mate with the apertures in the locking member 203 to couple the locking member 203 to the retaining component 201. Furthermore, other structural features and components may be used to permit repetitive coupling and decoupling of the locking member 203 to the retaining component 201, including hook-and-loop fasteners, threaded fasteners such as screws, or the like. The concept merely requires that there is some mating feature on each of the locking member 203 and the second coupling portions 232 to permit repetitive coupling of the locking member 203 to and decoupling of the locking member 203 from the retaining component 201, and more specifically the second retaining section 230 thereof. Furthermore, similar to the discussion above with regard to the first coupling portions 212, in some embodiments the locking member 203 may be omitted and the second coupling portions 232 may include the locking protuberances that interact with the backer card 110 to secure the first retention member 200 to the backer card 110.

In the exemplified embodiment, the first coupling portion 212 of the first retaining section 210 comprises two separate portions/regions of the first retaining section 210 to which the locking member 202 is coupled (one on each leg 216, 217). Similarly, the second coupling portion 232 of the second retaining section 230 comprises two separate portions of the second retaining section 230 to which the locking member 203 is coupled (one on each leg 236, 237). Although two separate locking members 202, 203 are illustrated in the drawings and described above, in some embodiments a single locking member may be used to couple to all of the first and second coupling portions 212, 232 (i.e., the single locking member may include four locking protuberances to matingly cooperate with the four apertures 221, 241). Furthermore, in some embodiments the first coupling portion 212 may comprise only a single coupling portion on one of the first and second legs 216, 217 (most likely the first leg 216) and the second coupling portion 232 may comprise only a single coupling portion on one of the first and second legs 236, 237 (most likely the first leg 236). In such embodiment, a locking member may couple to the first and second coupling portions 212, 232 to secure the retaining component 201 to the backer card 110 or the like. Thus, many variations and permutations are possible as noted herein.

As noted above, the retaining component 201 also comprises a third retaining section 250 that extends between (or is located between) the first and second retaining sections 210, 230. Thus, the third retaining region 250 is the region of the retaining component 201 located between the first retaining region 210 and the second retaining region 230. The third retaining region 250 is configured to retain the third product 103 between the retaining component 201 and the backer card 201. To achieve this, in the exemplified embodiment the third retaining region 250 comprises a first notch 251 and a second notch 254 that are formed into the front edge 207 of the retaining component 201 and extend towards the rear edge 208 of the retaining component 201. In the exemplified embodiment, each of the first and second notches 251, 254 are rectangular-shaped cutouts formed into the front edge 207 of the retaining component 201. However, the invention is not to be limited by the shape of the first and second notches 251, 254 in all embodiments and they may be rounded, V-shaped, or the like in other embodiments.

The first notch 251 comprises a third nesting region 252 and a third access region 253 that forms a passageway into the third nesting region 252 at the front edge 207 of the retaining component 201. Thus, a portion of the third product 103 may pass through the third access region 253 and into the third nesting region 252 for nesting of that portion of the third product 103. The second notch 254 comprises a fourth nesting region 255 and a fourth access region 256 that forms a passageway into the fourth nesting region 255 at the front edge 207 of the retaining component 201. Another portion of the third product 103 may pass through the fourth access region 256 and into the fourth nesting region 255 for nesting of that portion of the third product 103. In the exemplified embodiment, the first and second notches 251, 254 together serve to retain the third product 103 between the retaining component 201 and the backer card 110 when the retaining component 201 is coupled to the backer card 110 as described herein. In alternative embodiments, only one of the first and second notches 251, 254 may be needed to retain the third product 103.

The third retaining section 250 comprises a portion 259 of the front edge 207 of the retaining component 201. The portion 259 of the front edge 207 extends between the first and second notches 251, 254. Furthermore, the portion 259 of the front edge 207 is recessed relative to the distal ends 218, 219, 238, 239 of the first and second retaining sections 210, 230 of the retaining component 201. Furthermore, the portion 259 of the front edge 207 is recessed relative to the stopper walls 220, 240. This permits the portion 259 of the front edge 207 to assist in securing the third product 103 as the portion 259 of the front edge 207 may contact and press the third product 103 against the backer card 110.

Referring to FIGS. 11-14 concurrently, the details of the second retention member 300 will be briefly described. The features of the second retention member 300 are similar to those of the first retention member 200 and thus only the differences of the second retention member 300 relative to the first retention member 200 will be described. It should be appreciated that the description regarding the structure and function of the first retention member 200 is applicable to the second retention member 300 except for the differences described below. Similar numbering is used to described the features of the second retention member 300 as was used to describe the similar features of the first retention member 200 except that the 300-series of numbers will be used. For features that are shown and designated in the drawings but not described, the description of the similar feature with regard to the first retention member 200 is applicable. The second retention member 300 has a different size and different dimensions relative to the first retention member 200. Furthermore, the second retention member 300 comprises a first retaining section 310 and a second retaining section 330, but does not include any additional securing sections.

The second retention member 300 comprises a retaining component 301 and a locking member 302. The retaining component 301 comprises the first retaining section 310 and the second retaining section 330. One of the differences between the second retention member 300 and the first retention member 200 is that there is no third retaining section of the second retention member 300. Rather, the first and second retaining sections 310, 330 are directly adjacent to one another. The first retaining section 310 comprises a first collar portion 311 and a first coupling portion 312. The first collar portion 311 is visually divided from the first coupling portion 312 by a stopper wall 320. The first collar portion 311 defines a first slot 313 that is similar to the first slot 213 of the first collar portion 211 of the first retaining member 200 described above.

The second retaining section 330 comprises a second collar portion 331 and a second coupling portion 332. The second collar portion 331 is visually divided from the second coupling portion 332 by a stopper wall 340. The second collar portion 331 defines a second slot 333. In the exemplified embodiment, the second slot 333 has a rectangular shape, which is different than the circular shape of the second slot 233 described above.

Another difference between the second retention member 300 relative to the first retention member 200 is that for the first retention member 200 each of the first and second retaining sections 210, 230 includes two distinct coupling portions 212, 232. However, with the second retention member 300, the first and second retaining sections 310, 330 share one of the legs so that there are a total of three coupling portions 312, 332. Each of the coupling portions 312, 333 includes an aperture 321, 341 just as with the first retention member 200. However, in this embodiment there is only a single locking member 302 including a body portion 304 and a plurality of locking protrusions 305. The plurality of locking protrusions 305 of the locking member 302 enter into each of the apertures 321, 341 of the coupling portions 312, 333 to couple the locking member 302 to the second retention member 300 in a similar manner to that which was described above. For the remaining details of the second retention member 300, the description of the first retention member 200 is applicable.

The manner of use of the first retention member 200 will now be described with reference to FIGS. 1-5. When the first retention member 200 is coupled to the backer card 110, the first and second slots 213, 233 and the first and second notches 251, 254 become fully enclosed slots and notches. Specifically, as noted above the first and second slots 213, 233 and the first and second notches 251, 254 are open at the front edge 207 of the retention component 201. However, when the front edge 207 of the retention component 201 is positioned adjacent to the front surface 111 of the backer card 110, the front surface 111 of the backer card 110 encloses the first and second slots 213, 233 and the first and second notches 251, 254. Thus, when the first retention member 200 is coupled to the backer card 110 as described herein, the combination of the retention component 201 and the backer card 110 forms four substantially enclosed nesting regions (i.e., the nesting regions 214, 234, 252, 255) within which portions of products can be positioned for packaging.

To form the packaged kit of products 100, first, the products 102, 103, 104 are positioned on the backer card 110. Next, the first retention member 200 is translated towards the backer card 110 so that the first and second coupling portions 212, 232 enter into and through the through-holes 115 in the backer card 110. Specifically, the legs 216, 217, 236, 237 are slid through the through-holes 115 until the stopper walls 220, 240 contact the front surface 111 of the backer card 110, thereby preventing further insertion of the legs 216, 217, 236, 237 through the through-holes 115. When so inserted, a majority of the first retention member 200 is located adjacent to the front surface 111 of the backer card 110 and a small portion of the first retention member 200 that includes the first and second coupling portions 212, 232 and the apertures 221, 241 thereon is located adjacent to the rear surface 112 of the backer card 110.

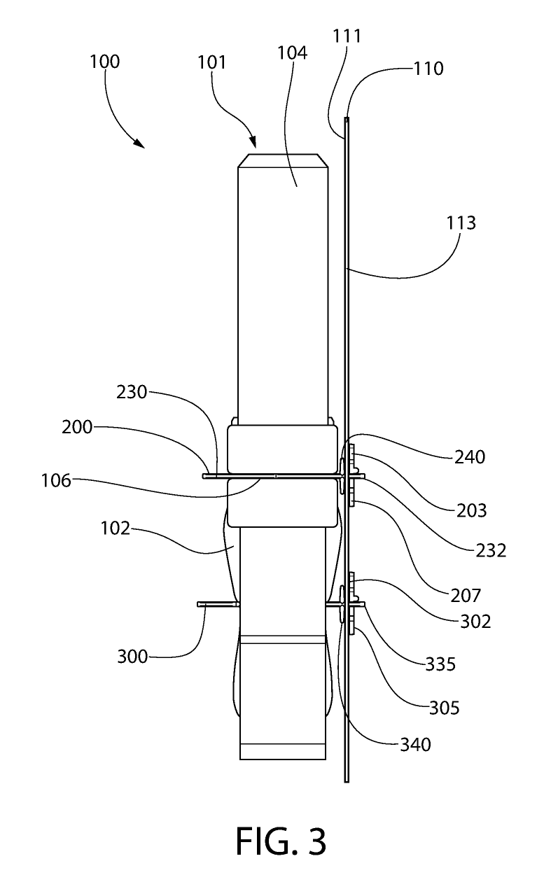

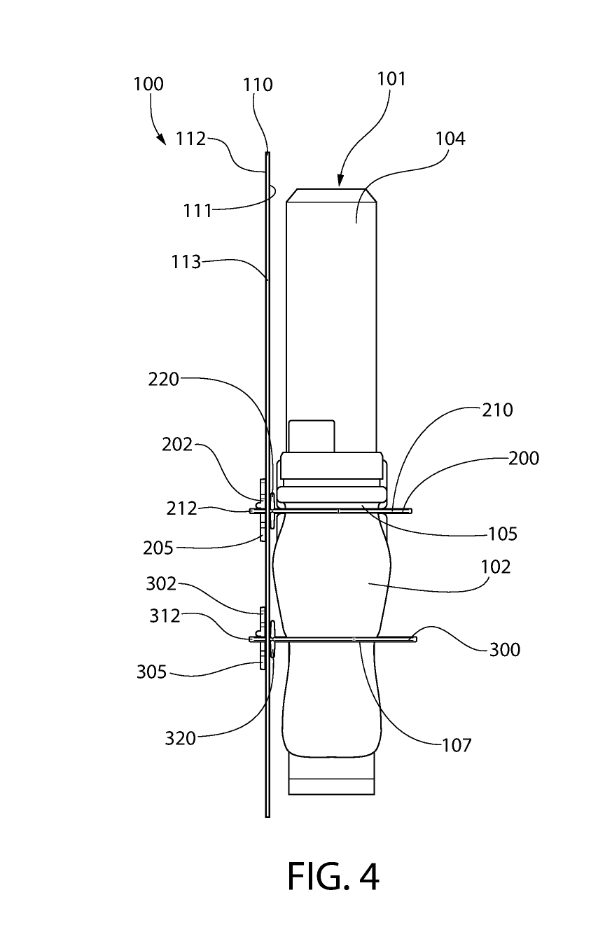

In this position, the product 101 (or products 102, 103, 104) are trapped or sandwiched between the first retention member 200 and the backer card 110. Thus, once in this position the locking member 202 is coupled to the retaining component 201 by inserting the locking protrusions 205 of the locking member 202 through the apertures 221 in the first coupling portions 212. Similarly, the locking member 203 is coupled to the retaining component 201 by inserting the locking protrusions 207 of the locking member 203 through apertures 241, 241. The locking protrusions 205, 207 detachably secure the locking members 202, 203 to the retaining component 201 to couple the first retention member 200 to the backer card 110. With the first retention member 200 coupled to the backer card 110 as described herein, the backer card 110 is sandwiched between the stopper walls 220, 240 and the locking members 202, 203. As best seen in FIGS. 3 and 4, the backer card 110 is sandwiched between the stopper walls 220, 240 of the retaining component 201 and the locking members 202, 203.

In addition to being coupled to the backer card 110 as described herein above, the first retention member 200 secures all of the products 101 to the backer card 110, which in the exemplified embodiment entails securing the first product 102, the second product 104, and the third product 103 to the backer card 110. Specifically, as the first retention member 200 is translated towards the backer card 110, an upper waist portion 105 of the first product 102 passes through the first access region 215 of the first slot 213 and comes to rest within the first nesting region 214 of the first slot 213. Thus, the first product 102 becomes retained by the first collar portion 211 of the first retaining section 210. Similarly, a waist portion 106 of the third product 103 passes through the second access region 235 of the second slot 233 and comes to rest within the second nesting region 234 of the second slot 233. Thus, the third product 103 becomes retained by the second collar portion 231 of the second retaining section 230. At the same time, portions of the second product 104 enter into the first and second notches 251, 254 of the third retaining section 250 of the retaining component 201 of the first retention member 200.

In the exemplified embodiment, the upper waist portion 105 of the first product 102 has a reduced cross-sectional area relative to portions of the container 102 that are located above and below the upper waist portion 105 of the container 102. Stated another way, the upper waist portion 105 of the first product 102 has a cross-sectional area that is less than the cross-sectional area of the first slot 213. The portions of the first product 102 that are above and below the upper waist portion 105 have a cross-sectional area that is greater than the cross-sectional area of the first slot 213. As a result, the first product 102 can not slide through the first slot 213 in the axial direction of the first product 102. The same is true of the waist portion 106 of the second product 104 that is located within the second securing region 128.

In the exemplified embodiment, the waist portion 105 of the first product 102 is retained within the first slot 213 of the first retaining section 210 and the waist portion 106 of the second product 104 is retained within the second slot 233 of the second retaining portion 230. In this embodiment, the third product 103 is a dish having a floor and an annular wall extending upwardly from the wall. In this embodiment, portions of the annular wall extend into the first and second notches 251, 254 to thereby retain the third product 103 (i.e., the dish) between the retaining component 201 of the first retention member 200 and the backer card 110. The portion 259 of the front edge 207 of the retaining component 201 that is located within the third retaining section 250 may contact the floor of the dish or third product 103 to more securely retain the third product 103 while limiting the movement thereof.

In some embodiments, the first retention member 200 alone may be sufficient to retain all of the products 101 on the backer card 110. In other embodiments, the first retention member 200 may be used in combination with zip ties to retain the products 101 on the backer card 110. In still other embodiments, the second retention member 300 may be used alongside of the first retention member 200 to retain the products 101 on the backer card. In such embodiments, the second retention member 300 is similarly coupled to the backer card 110 with the products 101 sandwiched between the second retention member 300 and the backer card 110. In the exemplified embodiment a lower waist portion 107 of the first product 102 is positioned within the first slot 313 of the second retention member 300. Furthermore, when the second product 104 is a bubble generating device as exemplified (such as a bubble generating gun), a portion of the handle of the bubble generating gun may be positioned within the second slot 333 of the second retention member 300. In this embodiment, the second retention member 300 does not assist with the retention of the third product 103 on the backer card 110, although it could in other embodiments. Thus, in some embodiments the first and second retention members 200, 300 may be used to collectively secure the products 101 (i.e., the first product 102, the second product 104, and the third product 103) to the backer card 110.

The first and second retention members 200, 300 can be separated from the backer card 110 easily by separating the locking members 202, 203, 302 from the retaining components 201, 301 of the first and second retention members 200, 300. Specifically, the locking members 202, 203, 302 can be separated from the retaining components 201, 301 by pulling upwardly on the locking members 202, 203, 302 with sufficient force to pull the locking protuberances 205, 207, 305 out of the apertures 221, 241, 321. Thus, no cutting element (knife, scissors, etc.) is needed to fully access the products 101 after purchase.

While the invention has been described with respect to specific examples including presently preferred modes of carrying out the invention, those skilled in the art will appreciate that there are numerous variations and permutations of the above described systems and techniques. It is to be understood that other embodiments may be utilized and structural and functional modifications may be made without departing from the scope of the present invention. Thus, the spirit and scope of the invention should be construed broadly as set forth in the appended claims.

1. A packaged kit of products comprising:
a backer card having a front surface, an opposite rear surface, and a plurality of through-holes formed through the backer card from the front surface to the rear surface; and
a first retention member comprising:
a retaining component positioned adjacent to the front surface of the backer card, the retaining component comprising a first retaining section for securing a first product between the retaining component of the first retention member and the backer card and a second retaining section for securing a second product between the retaining component of the first retention member and the backer card, each of the first and second retaining sections comprising at least one coupling portion extending through one of the plurality of through-holes in the backer card; and
at least one first locking member positioned adjacent to the rear surface of the backer card, the first locking member comprising at least one connector that cooperatively mates with one of the coupling portions of the first and second retaining sections of the retaining component to couple the first locking member to the retaining component, secure the first retention member to the backer card, and retain the first and second products between the backer card and the retaining component of the first retention member.

2. The packaged kit of products of claim 1 wherein each of the first and second retaining sections of the retaining component comprises at least two of the coupling portions, wherein each of the coupling portions comprises an aperture, and further comprising two of the first locking members, each of the first locking members comprising two of the connectors each comprising a protuberance that cooperatively mates with the aperture of one of the coupling portions to couple the first locking members to the retaining component of the first retention member.

3. (canceled)

4. The packaged kit of products of claim 1 wherein the first retaining section of the retaining component comprises a first collar portion that defines a first slot, the first slot comprising a first nesting region and a first access region that forms a passageway into the first nesting region at a front edge of the retaining component, and wherein when the first retention member is coupled to the backer card, the first product passes through the first access region of the first slot and into the first nesting region of the first slot so that the first product is trapped between the first collar portion and the front surface of the backer card.

5. The packaged kit of products of claim 4 wherein the second retaining section of the retaining component comprises a second collar portion that defines a second slot, the second slot comprising a second nesting region and a second access region that forms a passageway into the second nesting region at the front edge of the retaining component, and wherein when the first retention member is coupled to the backer card, the second product passes through the second access region of the second slot and into the second nesting region of the second slot so that the second product is trapped between the second collar portion and the front surface of the backer card.

6. (canceled)

7. The packaged kit of products of claim 1 wherein the first retaining section is U-shaped and comprises first and second legs terminating at respective distal ends so that a first slot is formed between the first and second legs of the first retaining section, and wherein the second retaining section is U-shaped and comprises first and second legs terminating at respective distal ends so that a second slot is formed between the first and second legs of the second retaining section, and wherein a portion of the first product nests within the first slot to secure the first product between the first retention member and the backer card, and wherein a portion of the second product nests within the second slot to secure the second product between the first retention member and the backer card.

8. The packaged kit of products of claim 7 wherein the retaining component of the first retention member comprises an upper surface, a lower surface, and a peripheral edge extending between the upper and lower surfaces, and further comprising a stopper wall extending from each of the first and second legs of each of the first and second retaining sections of the retaining component, each of the stopper walls oriented substantially perpendicular to the upper and lower surfaces of the retaining component to prevent over-insertion of the retaining component through the through-holes in the backer card.

9. (canceled)

10. The packaged kit of products of claim 1 wherein the retaining component of the first retention member further comprises a third retaining section for securing a third product between the retaining component of the first retention member and the backer card, the third retaining section extending between the first and second retaining sections.

11. The packaged kit of products of claim 10 wherein each of the first and second retaining sections of the retaining component are U-shaped, and wherein the third retaining section of the retaining component comprises a first notch adjacent to the first retaining section and a second notch adjacent to the second retaining section, and wherein portions of the third product nest within the first and second notches to retain the third product between the retaining component of the first retention member and the backer card.

12. The packaged kit of products of claim 10 wherein the first product is a bubble solution container, the second product is a bubble generating device, and the third product is a dish.

13. (canceled)

14. The packaged kit of products of claim 1 further comprising:
a second retention member positioned adjacent to the front surface of the backer card in a spaced apart manner from the first retention member, the second retention member comprising:
a second retaining component comprising a first retaining section for securing the first product between the second retaining component and the backer card and a second retaining section for retaining the second product between the second retaining component and the backer card; and
a second locking member positioned adjacent to the rear surface of the backer card and coupled to the second retaining component to secure the second retention member to the backer card.

15. A retention member comprising:
a retaining component comprising:
a first retaining section comprising a first collar portion and a first coupling portion, the first collar portion defining a first slot comprising a first nesting region and a first access region that forms a passageway into the first nesting region at a front edge of the retaining component; and
a second retaining section comprising a second collar portion and a second coupling portion, the second collar portion defining a second slot comprising a second nesting region and a second access region that forms a passageway into the second nesting region at the front edge of the retaining component; and
at least one locking member configured to be transitioned between: (1) a locked state in which the at least one locking member is coupled to at least one of the first coupling portion of the first retaining section and the second coupling portion of the second retaining section; and (2) an unlocked state in which the at least one locking member is separated from each of the first and second retaining sections.

16. The retention member of claim 15 wherein the retaining component further comprises a third retaining section extending between the first and second retaining sections, the third retaining section comprising a first notch having a third nesting region and a third access region that forms a passageway into the third nesting region at the front edge of the retaining component and a second notch having a fourth nesting region and a fourth access region that forms a passageway into the fourth nesting region at the front edge of the retaining component.

17. The retention member of claim 16 wherein each of the first and second collar portions is U-shaped and wherein the first notch is adjacent to the first collar portion and the second notch is adjacent to the second collar portion, and wherein a portion of the front edge of the retaining component within the third retaining section and positioned between the first and second notches is recessed relative to distal ends of the first and second retaining sections of the retaining component.

18. The retention member of claim 15 further comprising at least one stopper wall extending perpendicular to an upper surface of the retaining component that divides the first retaining section into the first collar portion and the first coupling portion and at least one stopper wall extending perpendicular to the upper surface of the retaining component that divides the second retaining section into the second collar portion and the second coupling portion.

19. (canceled)

20. (canceled)

21. The retention member of claim 15 wherein the first coupling portion comprises at least one aperture and the second coupling portion comprises at least one aperture, and wherein the at least one locking member comprises a locking protuberance that correspondingly mates with the apertures of at least one of the first and second coupling portions to couple the at least one locking member to at least one of the first and second coupling portions of the first and second retaining sections.

22. The retention member of claim 15 wherein the first retaining section is U-shaped and comprises first and second legs and the second retaining section is U-shaped and comprises first and second legs, and wherein the first coupling portion of the first retaining section comprises a first aperture formed into the first leg of the first retaining section adjacent to a distal end of the first leg of the first retaining section and a second aperture formed into the second leg of the first retaining section adjacent to a distal end of the second leg of the first retaining section, and wherein the second coupling portion of the second retaining section comprises a third aperture formed into the first leg of the second retaining section adjacent to a distal end of the first leg of the second retaining section and a fourth aperture formed into the second leg of the second retaining section adjacent to a distal end of the second leg of the second retaining section.

23. The retention member of claim 15 wherein the retaining component comprises the first retaining section, the second retaining section, and a third retaining section extending between the first and second retaining sections, and wherein the retaining component is a monolithic structure and the locking member is a separate component from the retaining component.

24. (canceled)

25. A packaged kit of products comprising:
a backer card having a front surface, an opposite rear surface, and at least one through-hole formed through the backer card from the front surface to the rear surface; and
a monolithic retaining component positioned adjacent to the front surface of the backer card, the retaining component comprising:
a first retaining section securing a first product between the retaining component and the backer card;
a second retaining section securing a second product between the retaining component and the backer card; and
a third retaining section securing a third product between the retaining component and the backer card; and
wherein the first product is a bubble solution container, the second product is a bubble generating device, and the third product is a dish.

26. The packaged kit of products of claim 25 further comprising:
the first retaining section comprising a first collar portion that defines a first slot, a portion of the first product nesting in the first slot;
the second retaining portion comprising a second collar portion that defines a second slot, a portion of the second product nesting in the second slot; and
the third retaining portion comprising first and second notches that are spaced apart from one another, portions of the third product nesting within each of the first and second notches;
wherein the third retaining section extends between the first and second retaining sections.

27. The kit of products of claim 26 wherein each of the first and second retaining sections comprises a coupling portion extending through the through-hole in the backer card to couple the retaining component to the backer card and retain the first, second, and third products between the backer card and the retaining component.
